(19) United States
(12) Patent Application Publication
(10) Pub. No.: US 2009/0210244 A1
(43) Pub. Date: Aug. 20, 2009

(54) TRUSTED ACQUAINTANCES NETWORK SYSTEM

(75) Inventors: Jari Koister, Stockholm (SE); Thomas B. McCleary, Oakland, CA (US); Michael Micucci, San Francisco, CA (US)

Correspondence Address: LAW OFFICES OF MIKIO ISHIMARU, 333 W. EL CAMINO REAL, SUITE 330, SUNNYVALE, CA, 94087, US

(73) Assignee: TN20 INCORPORATED, San Francisco, CA (US)

(21) Appl. No.: 12/278,277

(22) PCT Filed: Feb. 5, 2007
(86) PCT No.: PCT/US07/03257

§ 371 Date: Aug. 4, 2008

Related U.S. Application Data
(60) Provisional application No. 60/765,110, filed on Feb. 4, 2006.

(51) Int. Cl. G06Q 99/00

(52) U.S. Cl. 705/1

(57) ABSTRACT

A trusted acquaintances network system [700] includes: providing a network system [104] with a computer system [105 ]; inputting information about a plurality of users to the network with each of the plurality of users having a different level of trustworthiness and a different rating of further information; and displaying trustworthy data from the network based on the different levels of trustworthiness and the different ratings of the further information.

### TECHNICAL FIELD

The present invention relates generally to network systems, and more particularly to discovering high-value information through the Internet network system.

### BACKGROUND ART

On the Internet, information is commonly found through using search engines, groups, and online stores. In their most basic form these functions only provide references to information without qualifying the data beyond the syntactical match of a search. The problems with this approach are for example:
1) The user must generally search a large amount of information before they find the right information, and information they trust.
2) The syntactical match does not provide any level of confidence in the quality or accuracy of the information provided.

There exist many different approaches to address these problems. Semantic tagging allows users to do semantic annotation to information. The belief is that user will be able to find relevant information faster by using the semantic annotations in their search. It is also believed that the fact that something has been tagged, is an indication that it is considered interesting and relevant information. The frequency of tagging for a specific information element also provides an indication of how “good” the information can be considered.

Rating and recommendations in groups and forums are also becoming popular and adds additional mechanisms for users to find good and relevant information.

However, there is no way of determining the trustworthiness of the information that is found and, in some cases, even reliable sources of information have been spoofed or planted with unreliable information.

Solutions to these problems have been long sought but prior developments have not taught or suggested any solutions and, thus, solutions to these problems have long eluded those skilled in the art.

### DISCLOSURE OF THE INVENTION

The present invention provides a trusted acquaintances network system that includes: providing a network system including a computer system; inputting information about a plurality of users to the network with each of the plurality of users having a different level of trustworthiness and a different rating of further information; and displaying trustworthy data from the network based on the different levels of trustworthiness and different ratings of the further information.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a trusted online network of users in accordance with an embodiment of the present invention;

FIG. 2 is an information item and related annotations in accordance with another embodiment of the present invention;

FIG. 3 is a social network in accordance in accordance with another embodiment of the present invention;

FIG. 4 is a visualization of trust level in accordance with an embodiment of the present invention;

FIG. 5 is trusted recommendations as a filter to the wealth of Internet information in accordance with another embodiment of the present invention;

FIG. 6 is a flow diagram for the trusted acquaintances network system in accordance with another embodiment of the present invention; and

FIG. 7 is a flow diagram for the trusted acquaintances network system in accordance with a further embodiment of the present invention.

### BEST MODE FOR CARRYING OUT THE INVENTION

The following embodiments are described in sufficient detail to enable those skilled in the art to make and use the invention, and it is to be understood that other embodiments would be evident based on the present disclosure and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

Likewise, the drawings showing embodiments of the apparatus/device are semi-diagrammatic and not to scale and, particularly, some of the dimensions are for clarity of presentation and are shown greatly exaggerated in the drawing FIGs.

The present invention provides a system for automatically presenting a user with highly relevant information based on a specification of the users trusted social online network, ratings and recommendations, and semantic annotations.

An aspect of the invention of this invention is the fact that the system allows a trusted acquaintances network system to present to a user the information of interest for the user by using the a specified social network with associated trust levels. It also considers the ratings and recommendations that other users in a user's social network have done.

The system provides a user with highly trustworthy and accurate recommendations for products and services by:
1) Relating the information to a specific topic of current interest, and
2) using the ratings and recommendations done by other users that are in the users social network and considered trustworthy (in the specific subject matter) by the user, and
3) using reputation of users within a forum or with respect to subject matter, or both, and
4) using semantic annotation to find relevant data.

A user specifies a social network, which includes specification of trust, the trust being explicitly assigned or derived by annotations made by the user or other users. Such a specification involves relationships or acquaintances with other users and the level of trust and reputation to those users. Trust and reputation can be relative to a subject matter. The subject matter is defined as a topic, which is further defined in the trusted acquaintances network system as a semantic specification such as a set of semantic tags.

When a user discovers information, the user is performing the functions within the context of a topic. A topic is defined as the group or forum that is subject to the discussion or a set of semantic tags. Topics can overlap, or one topic can be a subset of another topic.

The present invention will present information to the user in the context of the current topic. The information presented is selected based on what other users in the users social network has identified as interesting, highly ranked, valuable information. Only information identified by users that the user consider trustworthy will be presented. Selected information will be prioritized based on the trustworthiness and reputation of the users.

Through the present invention users will be presented with information and recommendations related to products and services that with a high degree of likelihood will be of high interest to the user.

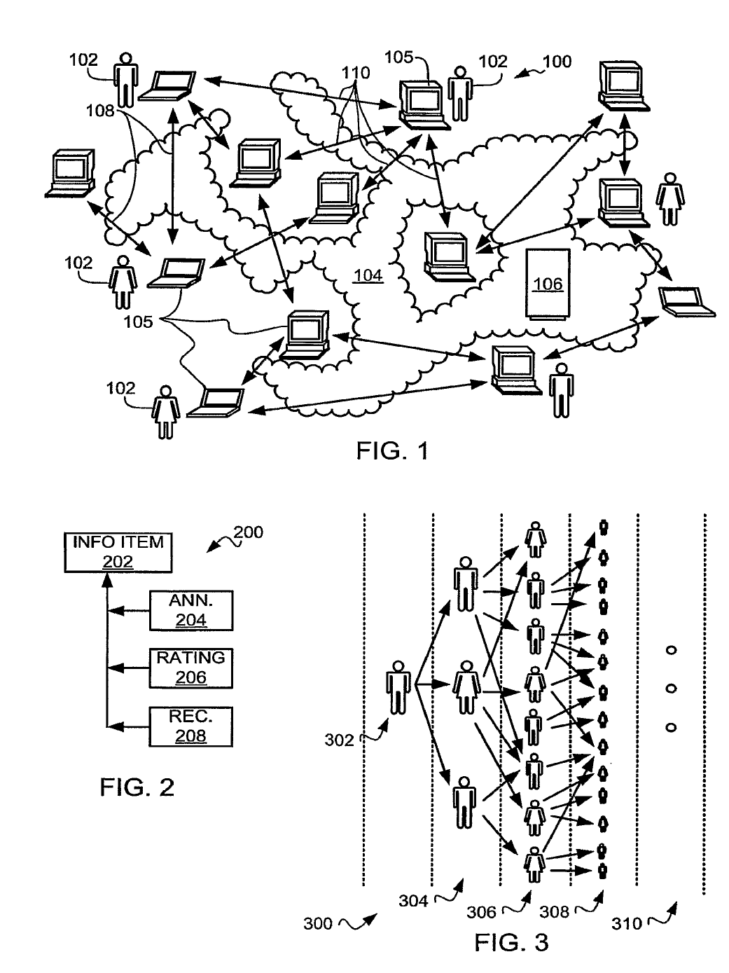

Referring now to FIG. 1, therein is shown a trusted acquaintances network system 100 of users 102 in accordance with an embodiment of the present invention. The trusted acquaintances network system 100 is a network of the users 102 that have a relationship or acquaintance of some sort on a network, such as the Internet 104. This relationship or acquaintance may or may not exist outside the Internet 104. These relationships or acquaintances can be modeled in various ways. For example, each relation or acquaintance can be characterized with regards to at least:
1) Type of relationship or acquaintance and trust level relative to a topic or group.
2) Topics that are subject to trust and the level of trust.
3) Reputation on subject matter and in the forum of the subject matter. The reputation of a user in a specific topic context would be in tuples consisting of user, topic, forum, and reputation express.

The users 102 use computer systems 105 to connect to the Internet 104, which is represented by a conventional Internet cloud. The Internet 104 has servers 106 which connect the users 102 through Internet connections 108. Among the Internet connections 108 are trusted online connections 110.

Referring now to FIG. 2, therein is shown an information unit 200 which relates to an example of an item of possible interest to a user. The information unit 200 is made up of an information item 202, which includes a semantic annotation 204, a rating annotation 206, and a recommendation annotation 208.

The semantic annotation 204 would be an information element (such as URLs) that can be annotated with semantic information such as tags. Semantic annotation can be of a variety of forms. The most common mechanism used on the Internet today is based on tagging. The Resource Description Framework (RDF) is a richer but also more complicated mechanism for semantic annotation. The basic benefit of semantic annotation is that users can associate a meaning to information. While these annotations are meaningful to users, they can also be used in automatic processing. The trusted acquaintances network system 100 includes a variety of semantic annotation formats, but semantic tags are currently the most common form of such annotations. A tag is simply a word that characterizes an information item. Consider the Uniform Resource Locator (ERL):

http://www.mountainbike.com/

It could have the tags such as the following associated to it: mountainbike; newsletter; clothing; trails; cycling; gear; community; etc.

The rating annotation 206 would be a number or a “good-bad” ranking that another user would assign to the information item 202.

The recommendation annotation 208 could be a commentary or can just be positive or negative.

An aspect of the present invention is a function that uses the trusted acquaintances network system 100 of FIG. 1 for a user to automatically suggest relevant information to the user 102 based on such factors as:
1) Annotations, ratings and recommendations done by other users in the trusted acquaintances network system 100.
2) The trust and characterizations on the trusted acquaintances network system 100.
3) Reputation of forum or user who submitted information.
4) Current context in which the user 102 is conducting information discovery or searching.

Referring now to FIG. 3, therein is shown a social network 300 in accordance with another embodiment of the present invention.

In the social network 300, an originator user 302 is considered to be a 1st degree user. Those who are in direct contact with the originator user 302 have a 2nd degree of relationship 304 with the originator user 302. Those who are in contact with the originator user 302 through a user having a 2d degree of relationship 304 have a 3d degree of relationship 306. Those who are in contact with the originator user 302 through the 2nd degree of relationship 304 and the 3rd degree of relationship 306 have a 4th degree of relationship 308. Similarly, those who are in contact with the originator user 302 through various other degrees of relationship extend to an nth degree of relationship 310.

There is a tremendous amount of information on the Internet. This information is rapidly growing and becoming overwhelming for individual users. Search engines are being improved to cope with the tremendous amount of information and new semantic mechanisms, such as tagging, are being introduced to help in the information categorization and search. Nevertheless, users still find it difficult to find trustworthy, relevant information fast.

The present invention is directed towards network systems generally and more specifically to a trusted acquaintances network system to help address this problem. In this system, one of the assumptions is that users value peer input highly and thus are willing to base their information search on input from other users, such as friends or friends of friends, that they trust and are deemed reputable.

The set of users with which the originator user 302 has a relationship 304-310 on the Internet is referred to as the online social network of the originator user 302. The relationship can be that the users have each others email addresses, instant messaging ID, or that the users are registered in the trusted acquaintances network system 100 and have exchanged their trusted acquaintances network system identities, or any other formal or semi-formal relationship that can be captured in the trusted acquaintances network system 100.

It should be noted that the trusted acquaintances network system 100 does not require the users in the social network 300 to be registered trusted acquaintances network system users, although that would create even more possibilities for automation and support. The users in the social network 300 are each at a defined degree of relationship from the originator user 302.

The trusted acquaintances network system 100 does, however, require that the originator user 302 has added the users in the second degree of relationship 304 to the originator user's trusted acquaintances network system contact book. Users in degrees of relationship larger than one are connected through the social network 300.

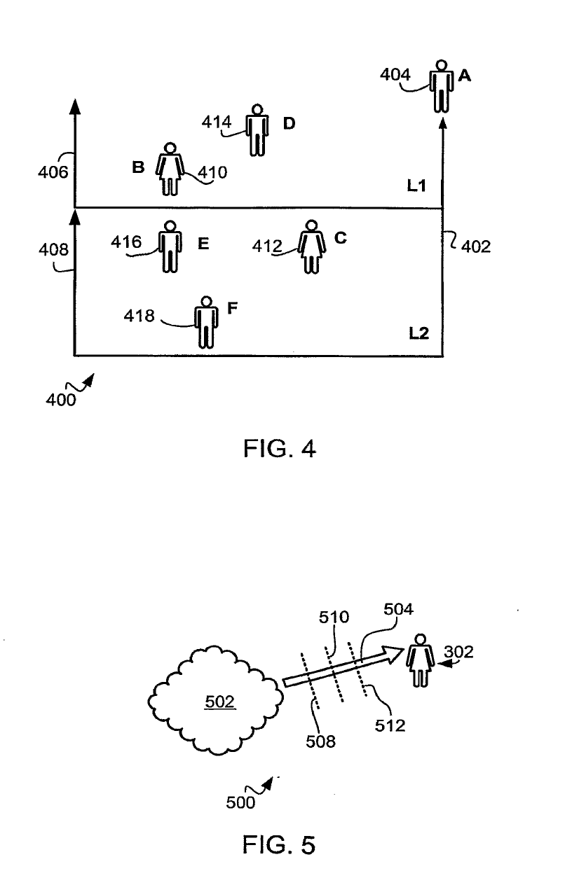

Referring now to FIG. 4, therein is shown a visualization of trust levels 400 in accordance with an embodiment of the present invention.

The visualization of trust levels 400 indicates increasing levels of trust by an arrow 402 towards a user A 404, who could be the originator user 302 of FIG. 3. For example, various users are categorized in two levels, such as a trust level L1 406 and a trust level L2 408.

The users are designated as a user B 410, a user C 412, a user D 414, a user E 416, and a user F 418.

Trust is a measure that an originator user 302 of FIG. 3 or the user A 404 assigns to users in his/her social network 300. The trusted acquaintances network system 100 mainly uses an ordinal scale for trust. This means that the originator user 302 can assign the trust level L1 406 to the user B 410. It also means that the originator user 302 can express if he/she trusts one user more than he/she trusts another user.

Thus, FIG. 4 shows exemplary expressions of trust in trusted acquaintances network system.
User A 404 trusts user B 410 on level Li.
User A 404 trusts user C 412 on level L2.
User A 404 trusts user D 414 on level LI.
User A 404 trusts user D 414 more that user B 410.
User A 404 trusts user C 412 less that user B 410.
User A 404 trusts user E 416 the same as he trusts user C 412
User A 404 trusts user F 418 less than user E 416.

The number of levels of trust can be explicitly or implicitly defined. Explicit definition can simplify the usage of trust, as a level can be directly assigned. Not setting a level will require at least one relation of trust to be defined.

The trusted acquaintances network system 100 of FIG. 1 allows users to assign ratings and recommendations to any information on the Internet. Generally, such ratings and recommendations are related to, for example, a product or service described in information on the Internet. For example, such information assumes that users can assign a rating that is between a maximum value (best available) and minimum value (worst available). This rating can be used for rankings, etc. The usage of the ratings depends on the measured attribute and the scale used. Although trusted acquaintances network system 100 support more advanced scales, it is expected that the ordinal scale to be the most commonly applicable.

User reputation is a measure of the perceived reputation for a user within the context of a specific topic and forum. Reputation is modeled on a numeric scale, and users can be ordered based on their reputation with respect to a specific subject matter and forum.

A recommendation is an associated description of the rating that defines the context of the rating and how the user came to that rating.

A rating is generally also in the context of a topic, but need not to be so.

Thus, the present invention is based on the concept of social network, trust, reputation, topic, ratings, and recommendations.

The present invention is a system that allows the trusted acquaintances network system 100 to present to the originator user 302 information in the context of a topic, that has been rated high by other users in the social network that the user has a high-level of trust in users who generally have a high reputation with respect to the topic.

Trust is very seldom applied generally. Rather, trust is related to some specific subject matter, area of concern or context. Likewise, reputation is often with earned with respect to a subject and within a specific forum of users. The trusted acquaintances network system allows a user to associate trust and reputation with respect to the topic.

Referring now to FIG. 5, therein is shown a trusted recommendation system 500 for the Internet 104 of FIG. 1 as filters to a wealth of Internet information 504 for the originator user 302.

By way of example, the various filters could include a topic filter 508, a social network filter 510, and trust filter 512.

The topic filter 508 would be used to filter the Internet information 504 to eliminate any topic, which is not of particular interest to the originator user 302. Then the social network filter 510 will be used to eliminate users who are unknown to the originator user 302 or who are too many degrees of relationship removed from the user 506 to be considered known by the originator user 302. The trust filter 512 would be used to eliminate those users who are less trustworthy or to specify the levels of trust that can be placed on various users.

A topic is a set of semantic annotations that defines an area of interest to a user: It can be finding a new television, or a new dentist in Chicago participating in Blue Cross. Examples of topics are:

Topic1: television, home, flatscreen, goodvalue, lcd

Topic2: dentist, surgery, chicago, bluecross

The trusted acquaintances network system 100 uses an algorithm that uses the above-defined concepts to find and present information to the originator user 302 such that the information is relevant, of high quality, and trustworthy.

The trusted acquaintances network system 100 requires the following data for its execution:
1) A defined trusted social network for the originator user 302 using the trusted acquaintances network system 100. This means there is a contact book in which users are defined.
2) Information items with which individual users can associate semantic annotations.
3) Information items with which individual users can associate ratings and recommendations.
4) A definition of a topic, which captures the essential semantic of a specific area of interest.
5) Explicitly defined or derived trust ratings for users and information items.
6) Explicitly defined or derived reputation rating for user and information items.
Where the originator user 302 has a defined social network S in which nodes represent other users with whom the originator user 302 has an online social relationship, an arc between any two nodes represents the relationship. The arc is annotated with information that characterizes the relationship.
This relationship information includes, but is not limited to, the following elements:
1) Type of relationship, for example: colleague, friend, acquaintance, etc.
2) Trust level, for example high, medium, low.
3) The subject of the trust, such as the set of semantic information defining a specific topic.
Items can be a plurality of things such as, but not limited to, the following:
1) A URL to some information on the Internet.
2) A block of text, such as a recommendation or comment, submitted to a service on the Internet.
3) Another user's semantic annotation.

Finally, the system is executed within the context of a topic. A topic is defined semantically. One way to define a topic is to associate a number of semantic tags. When a user is discovering information within the context of a topic, only information that is also associated with the same semantic context will be considered.

The trusted acquaintances network system 100 can be outlined as follows in accordance with another embodiment of the present invention:
Given a user U.
Given a semantic context C.
Given a social network S.
Give a set of items I.
Given a topic T.
Given a function Ft, that calculates a measure based in the trust and reputation associated with a user.

Select a subset I′ of items from I, that are relevant to the semantic context C.
Within S, select a subset F of users, that S:
Trusts generally.
Trusts within the defined context C.
Create an order set F′ that contains the elements of F order on descending order of trust and reputation based in the application of Ft.
For every user f, in F′ do the following:
Select the items collected, saved, rated or recommended by f in the context of
C in a set I′.
Order the I′ according to the recommendations of f.
Present to U the items in I′.

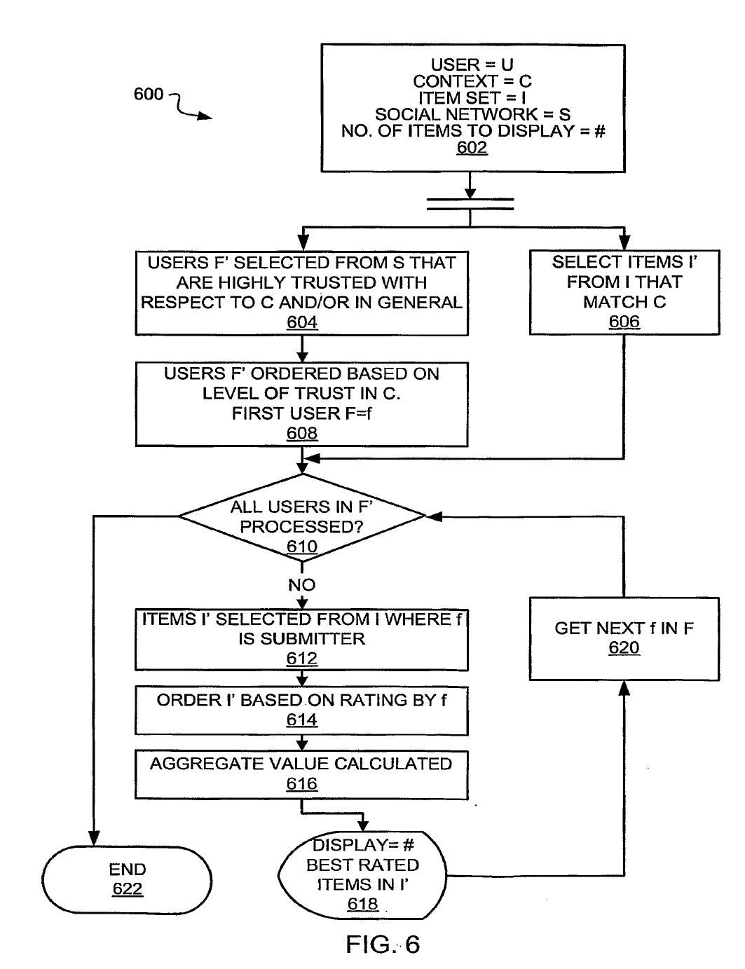

Referring now to FIG. 6, therein is shown a flow diagram for a trusted acquaintances network system 600 in accordance with an embodiment of the present invention. The trusted acquaintances network system 600 is a program method that could be used, for example, with the trusted acquaintances network system 100 of FIG. 1.

In the trusted acquaintances network system 600, the environment is first set in a block 602 in which the user=U, topic context=C, item set=I, social network=S, and the number of items to be display=#.

In a block 604, the social network 300 of FIG. 3 is traversed and the users in the field F′ (see note below) are selected that the user U has a high level of trust in for a specific topic. The levels of trust 400 from FIG. 4 are provided as arguments for the trusted acquaintances network system 100. A transitive trust, the trust for each user in the social network 300, is also calculated, but the function for this calculation is also provided as an argument to the trusted acquaintances network system 600.

In a block 604, users in a field F′ are selected from the social network S that are highly trusted with respect to the topic context C or are respected in general.

In a block 606, the item set I is selected that match the topic context C.

In a block 608, the users in the field F′ are ordered based on the calculated level of trust regarding the topic context C. The first user F in the field F′ is set equal to f.

In a decision block 610, all the users in the field F′ are processed sequentially. As long as all the users in field F′ have not been processed in the decision block 610, the program method proceeds to a block 612.

In the block 612, the “of interest” item set I′ is selected from the item set I where user f is the submitter.

In a block 614, the item set I′ is ordered based on the rating annotations that the users in the field F have given for the item set.

In a block 616, the aggregate value for trust and reputation is calculated for the user f, who submitted the information.

In a display block 618, the number of best rated items in the item set I are displayed.

In a block 620, the program method moves to obtain the next user in the field F and returns to the decision block 610.

In the decision block 610, when all the users in the field F have been processed, the program/method will end in the block 622.

In the block 604, the social network 300 of FIG. 3 is traversed and the users selected that the originator user U 302 has a high level of trust for a specific topic. The levels are provided as arguments for the system. A transitive trust is also calculated, but the function for this calculation is also provided as an argument to this system.

In the block 606, items are selected that match the current context for the users activity.

In the block 608, an ordered list is created based on the calculated trust.

In the block 614, the items are ordered on the ratings that the user has defined for an item.

In the block 616, the aggregates value for trust and reputation is calculated to for the user who submitted the data.

The trusted acquaintances network system 100 provides for discovering information based on activities of other users in the social network 300. Where the users rating of information and the trust levels related to the users and the reputation related to the users, includes:

providing an user-interface for information discovery;

providing an online trusted social network for a user;

providing a function T: A×B→t, that computes the trust that one user A has in another user B 410;

providing a function R: A×F×t→r, that computes the reputation for a user A, within a forum F, and with respect to a topic t;

providing topic context C;

discovering from provided information l, a subset of the information I′, by:
selecting information that has been rated high by user in the online semantic network,
selecting information that matches the topic context C,
sorting information according to ratings by the users and,
sorting information based on trust ratings of the users,

where, the user computer will display the subset I′ of information indicating the reputation of the users.

The various embodiments of the present invention have some of the following aspects:

The trusted acquaintances network system 100 allows users to create documented social networks without requiring all users in the social networks to be registered in one specific service.

The trusted acquaintances network system 100 allows a user to assign or the system to derive trust using a simple ordinal scale with an explicit and derived level of trust.

The trusted acquaintances network system 100 allows an infinite number of trust levels using a ordering derived from an ordinal definition of trust relative to and between all users.

The trusted acquaintances network system 100 allows the definition of a model for deriving trust to users that are of acquaintance degree 2 or larger.

The trusted acquaintances network system 100 allows a definition of trust (as defined above) relative to any topic that is defined in the trusted acquaintances network system 100.

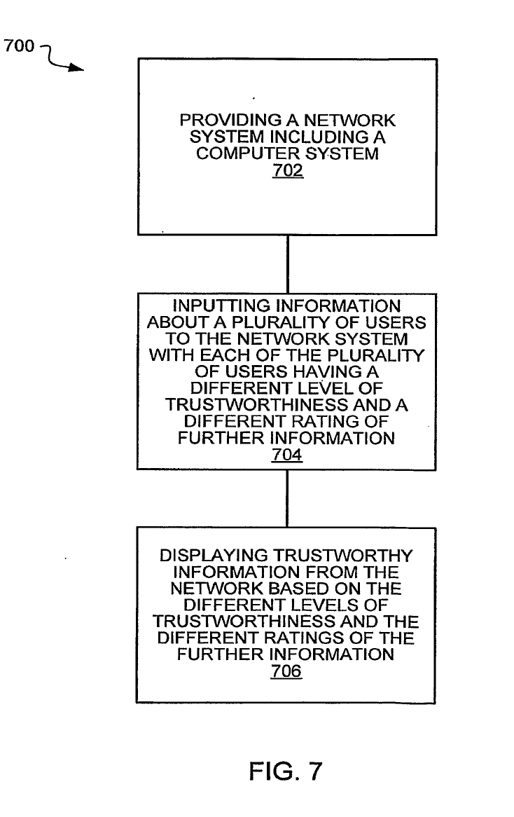

Referring now to FIG. 7, therein is shown a flow diagram for a trusted acquaintances network system 700 in accordance with a further embodiment of the present invention. The trusted acquaintances network system 700 includes: providing a network system including a computer system in a block 702; inputting data about a plurality of users to the network with each of the plurality of users having a different level of trustworthiness and a different rating for information in a block 704; and displaying trustworthy data from the network based on the different levels of trustworthiness and the different ratings of information in a block 706.

The trusted acquaintances network system 100 allows users to rate information in the system.

The trusted acquaintances network system 100 allows the trusted acquaintances network system 100 to present information based on the topic and what users in the social network have discovered relative to that topic.

The trusted acquaintances network system 100 allows the trusted acquaintances network system 100 to filter information through the social network according to the rating the users have assigned to it.

The trusted acquaintances network system 100 allows the trusted acquaintances network system 100 to filter information based on the trust level associated with users in the network.

The trusted acquaintances network system 100 allows the trusted acquaintances network system 100 to filter information based on topic in addition to social network, trust and ranking.

The trusted acquaintances network system 100 allows the trusted acquaintances network system 100 to present a reputation for users related to submitted information.

The trusted acquaintances network system 100 includes: providing a network system including a computer system; inputting data about a plurality of users to the network with each of the plurality of users having a different level of trustworthiness and a different rating of information; and outputting trustworthy data from the network based on the different levels of trustworthiness and the different ratings of information.

The trusted acquaintances network system 100 includes: a network system including a computer system; an input device for inputting data about a plurality of users to the network with each of the plurality of users having a different level of trustworthiness, reputation and different ratings of information; and an output device for outputting trustworthy data from the network based on the different levels of trustworthiness and different ratings of information.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A trusted acquaintances network system [700] comprising:
providing a network system [104] with a computer system [105];
inputting information about a plurality of users to the network system [104] with each of the plurality of users having a different level of trustworthiness and a different rating of further information; and
displaying trustworthy information from the network system [104] based on the different levels of trustworthiness and the different ratings of further information.

2. The system [700] as claimed in claim 1 wherein:
providing the network system [104] includes providing information on a plurality of topics; and
inputting the information includes using a topic context to select from the plurality of topics to provide the trustworthy information.

3. The system [700] as claimed in claim 1 wherein:
providing the network system [104] includes providing information on a user's social network [300]; and
inputting the information includes using further information from users in the user's social network [300] to provide the trustworthy information.

4. The system [700] as claimed in claim 1 wherein:
providing the network system [104] includes providing levels of trustworthiness of users in the network system [104] and recommendations of the users regarding the further information; and
inputting the information further comprises using the further information from users in selected levels of trustworthiness to provide the trustworthy information.

5. The system [700] as claimed in claim 1 wherein:
providing the network system [104] includes providing levels of trustworthiness of users in the network system [104] and recommendations of users on a plurality of topics; and
inputting the information includes selecting a topic from the plurality of topics and using recommendations of users in selected levels of trustworthiness to provide the trustworthy information.

6. A trusted acquaintances network system [700] comprising:
providing a network system [104] with a computer system [105];
inputting information about a plurality of users to the network system [104] with each of the plurality of users a having different level of trustworthiness and a different rating of data; and
displaying trustworthy data from the network system [104] resulting from calculation of the different levels of trustworthiness of each of the plurality of users and the different ratings of data.

7. The system [700] as claimed in claim 6 wherein:
providing the network system [104] includes providing information having a semantic notation, a rating, and a recommendation from users on a plurality of topics; and
inputting the information includes using a topic context to select from the plurality of topics to provide the trustworthy data.

8. The system [700] as claimed in claim 6 wherein:
providing the network system [104] includes providing information of different degrees of relationship [304] [306] [308] [310] of users on a user's social network [300]; and
inputting the information includes using data from users in the user's social network [300] within selected degrees to provide the trustworthy data.

9. The system [700] as claimed in claim 6 wherein:
providing the network system [104] includes providing levels of trustworthiness of users in the network system [104] and ratings of the users regarding the data; and
inputting the information further comprises using the data from users in selected levels of trustworthiness and the ratings to provide the trustworthy data.

10. The system [700] as claimed in claim 6 wherein:
providing the network system [104] includes providing levels of user reputation in the network system [104] and recommendations of users on a plurality of topics; and
inputting the information includes selecting a topic from the plurality of topics and using reputations of the user and recommendations of the user in selected topics to provide the trustworthy data.

11. A trusted acquaintances network system [100] comprising:
a network system [104]; and
a computer system [105] connected to the network system [104] for:
inputting information about a plurality of users to the network system [104] with each of the plurality of users having a different level of trustworthiness and a different rating of further information, and
displaying trustworthy information from the network system [100] [600] [700] based on the different levels of trustworthiness and the different ratings of further information.

12. The system [100] as claimed in claim 11 wherein:
the network system [104] is for providing information on a plurality of topics; and
the computer system [105] is for using a topic context to select from the plurality of topics to provide the trustworthy information.

13. The system [100] as claimed in claim 11 wherein:
the network system [104] is for providing information on a user's social network [300]; and
the computer system [105] is for using further information from users in the user's social network [300] to provide the trustworthy information.

14. The system [100] as claimed in claim 11 wherein:
the network system [104] is for providing levels of trustworthiness of users in the network system [104] and recommendations of the users regarding the further information; and
the computer system [105] is for using the further information from users in selected levels of trustworthiness to provide the trustworthy information.

15. The system as claimed in claim 11 wherein:
the network system [104] is for providing levels of trustworthiness of users in the network system [104] and recommendations of users on a plurality of topics; and
the computer system [105] is for selecting a topic from the plurality of topics and using recommendations of users in selected levels of trustworthiness to provide the trustworthy information.

16. A trusted acquaintances network system [100] comprising:
providing a network system [104]; and
a computer system [105] connected to the network system [104] for:
inputting information about a plurality of users to the network system [104] with each of the plurality of users having a different level of trustworthiness and a different rating of data; and
displaying trustworthy data from the network system [104] resulting from calculations of the different levels of trustworthiness of each of the plurality of users and the different ratings of data.

17. The system [100] as claimed in claim 16 wherein:
the network system [104] is for providing information having a semantic notation, a rating, and a recommendation from users on a plurality of topics; and
the computer system [105] is for using a topic context to select from the plurality of topics to provide the trustworthy data.

18. The system [100] as claimed in claim 16 wherein:
the network system [104] is for providing information of different degrees of relationship of users on a user's social network [300]; and
the computer system [105] is for using data from users in the user's social network [300] within selected degrees to provide the trustworthy data.

19. The system [100] as claimed in claim 16 wherein:
the network system [104] is for providing information of levels of trustworthiness of users in the network system [104] and ratings of the users regarding the data; and
the computer system [105] is for using the data from users in selected levels of trustworthiness and the ratings to provide the trustworthy data.

20. The system [100] as claimed in claim 16 wherein:
the network system [104] is for providing information of levels of user reputation in the network system [104] and recommendations of users on a plurality of topics; and
the computer system [105] is for selecting a topic from the plurality of topics and using reputations of the user and recommendations of the user in selected topics to provide the trustworthy data.
